(19) United States
(12) Patent Application Publication
(10) Pub. No.: US 2006/0031103 A1
(43) Pub. Date: Feb. 9, 2006

(54) Systems and methods for diagram data collection

(76) Inventor: David Scott Henry, Austin, TX (US)

Correspondence Address: MEYERTONS, HOOD, KIVLIN, KOWERT & GOETZEL, P.C., P.O. BOX 398, AUSTIN, TX, 78767-0398, US

(21) Appl. No.: 10/912,883

(22) Filed: Aug. 6, 2004

(51) Int. Cl. G06Q 40/00

(52) U.S. Cl. 705/4

(57) ABSTRACT

In some embodiments, information for determining fault may be entered into a computer system for determining fault in a vehicle accident. In some embodiments, a screen or multiple screens may be used to prompt a user for information. A display of certain aspects of the accident (e.g., vehicle representations, roadway configurations, and accident types) may also be used to graphically input information to help determine fault. In some embodiments, vehicle orientation and position may be entered along with information about the roadway configuration and conditions at the time of the accident. In some embodiments, graphical vehicles may be moved and rotated on a display and impact points may be entered for each vehicle. In some embodiments, multiple vehicles may be considered.

### BACKGROUND OF THE INVENTION

1. Field of the Invention

The present invention generally relates to computer systems. In particular, embodiments relate to systems and methods for processing insurance data.

2. Description of the Related Art

Insurance companies issue policies to cover vehicle accidents, theft, fire, etc. When an accident occurs, time may become a critical factor, especially for the people involved. For example, the vehicle owners may need to get their vehicles repaired. Drivers and passengers involved may need to cover medical expenses. Because of the large number of policies an insurance company may have issued, an insurance company may be processing a large number of claims at any one point in time. Before a claim is paid, an insurance company usually attempts to determine who was at fault. For example, if each driver was partially at fault, each driver's insurance company may need to pay at least part of the claim. Because of the large number of claims, and the need to pay claims as quickly as possible, efficiency in the fault determination process may be very important to insurance companies.

### SUMMARY OF THE INVENTION

In some embodiments, information for determining fault (e.g., involved parties information, accident information, and settlement information) may be entered into a computer system for determining fault in a vehicle accident. In some embodiments, a screen or multiple screens may be used to prompt a user for information. A display of certain aspects of the accident (e.g., vehicle representations, roadway configurations, and accident types) may also be used to graphically input information to help determine fault.

In some embodiments, vehicle orientation and position may be entered along with information about the roadway configuration and conditions at the time of the accident. In some embodiments, the roadway configuration may be entered or configured using input from a user (e.g., number of lanes, signs present, etc.). In some embodiments, vehicles may be moved and/or rotated on a graphical representation of a roadway configuration determined from previous input. In some embodiments, graphical vehicles may be moved and rotated on a display and impact points may be entered for each vehicle. In some embodiments, multiple vehicles may be considered. For example, data may be entered on three involved vehicles. Multiple designations and impact points may be selected to determine fault in the multiple vehicle accident.

### BRIEF DESCRIPTION OF THE DRAWINGS

A better understanding of the present invention may be obtained when the following detailed description of some embodiments is considered in conjunction with the following drawings, in which:

FIG. 1 illustrates an embodiment of a wide area network (“WAN”) for use with various embodiments.

FIG. 2 illustrates an embodiment of computer system that may be suitable for collecting data for a fault determination.

FIG. 3 illustrates an embodiment of a claims details screen.

FIG. 4 illustrates an embodiment of an additional information screen.

FIG. 5 illustrates an embodiment of a parties information screen.

FIG. 6 illustrates an embodiment of an accident information screen.

FIG. 7 illustrates an embodiment of an accident type selection screen.

FIG. 8 illustrates an embodiment of a roadway configuration selection screen.

FIG. 9 illustrates an embodiment of two vehicles and two sets of impact points.

FIG. 10 illustrates an embodiment of an investigation summary information screen.

FIG. 11 illustrates an embodiment of an investigation information screen for an involved party.

FIG. 12 illustrates an embodiment of a resolution information screen.

FIG. 13 illustrates an embodiment of a consultation report screen.

FIG. 14 illustrates an embodiment of a settlement information screen.

FIG. 15 illustrates a first embodiment of a graphically reported accident.

FIG. 16 illustrates a second embodiment of a graphically reported accident.

FIG. 17 illustrates a third embodiment of a graphically reported accident.

FIGS. 18a, 18b, and 18c illustrate snapshots of an accident at three points in time, according to an embodiment.

FIG. 19 is a flowchart of a method for collecting data to determine fault, according to an embodiment.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF SEVERAL EMBODIMENTS

### INCORPORATION BY REFERENCE

Embodiments described may be associated with insurance policies, claims under those policies, and policy applications. The following applications and patents related to policy processing, are fully incorporated herein by reference as if set forth herein:

U.S. patent application Publication No. 2004-0054557 published on Mar. 18, 2004 to Wahlbin et al., entitled “ESTIMATING PREMISES LIABILITY FOR AN ACCIDENT USING A COMPUTER SYSTEM” filed on Sep. 9, 2002;

U.S. patent application Publication No. 2004-0054558 published on Mar. 18, 2004 to Wahlbin et al., entitled “COMPUTERIZED METHOD AND SYSTEM FOR DETERMINING CLAIMANT STATUS IN PREMISES LIABILITY FOR AN ACCIDENT” filed on Sep. 9, 2002;

U.S. patent application Publication No. 2004-0049409 published on Mar. 11, 2004 to Wahlbin et al., entitled “COMPUTERIZED METHOD AND SYSTEM FOR DETERMINING BREACH OF DUTY IN PREMISES LIABILITY FOR AN ACCIDENT” filed on Sep. 9, 2002;

U.S. patent application Publication No. 2004-0054556 published on Mar. 18, 2004 to Wahlbin et al., entitled “COMPUTERIZED METHOD AND SYSTEM FOR DETERMINING CAUSATION IN PREMISES LIABILITY FOR AN ACCIDENT” filed on Sep. 9, 2002;

U.S. patent application Publication No. 2004-0054559 published on Mar. 18, 2004 to Wahlbin et al., entitled “COMPUTERIZED METHOD AND SYSTEM FOR DETERMINING THE CONTRIBUTION OF DEFENSES TO PREMISES LIABILITY FOR AN ACCIDENT” filed on Sep. 9, 2002;

U.S. patent application Publication No. 2002-0069091 published on Jun. 6, 2002 to Wahlbin et al., entitled “COMPUTERIZED METHOD OF LIABILITY ASSESSMENT FOR A MOTOR VEHICLE ACCIDENT” filed on Oct. 2, 2001;

U.S. patent application Publication No. 2002-0082873 published on Jun. 27, 2002 to Wahlbin et al., entitled “COMPUTERIZED METHOD AND SYSTEM OF DETERMINING RIGHT OF WAY AND LIABILITY FOR AN ACCIDENT” filed on Oct. 2, 2001;

U.S. patent application Publication No. 2002-0069092 published on Jun. 6, 2002 to Wahlbin et al., entitled “COMPUTERIZED METHOD AND SYSTEM OF ASSESSING AND ADJUSTING LIABILITY FOR AN ACCIDENT” filed on Oct. 2, 2001;

U.S. patent application Publication No. 2002-0062234 published on May 23, 2002 to Wahlbin et al., entitled “COMPUTERIZED METHOD AND SYSTEM OF ESTIMATING LIABILITY AND RANGE OF LIABILITY FOR AN ACCIDENT” filed on Oct. 2, 2001;

U.S. patent application Publication No. 2002-0055860 published on May 9, 2002 to Wahlbin et al., entitled “COMPUTERIZED METHOD AND SYSTEM OF DETERMINING RIGHT OF WAY IN AN ACCIDENT” filed on Oct. 2, 2001;

U.S. patent application Publication No. 2002-0062233 published on May 23, 2002 to Wahlbin et al., entitled “COMPUTERIZED METHOD AND SYSTEM OF ASSESSING LIABILITY FOR AN ACCIDENT USING IMPACT GROUPS” filed on Oct. 2, 2001;

U.S. patent application Publication No. 2002-0059097 published on May 16, 2002 to Wahlbin et al., entitled “COMPUTERIZED METHOD AND SYSTEM OF ASSIGNING AN ABSOLUTE LIABILITY VALUE FOR AN ACCIDENT” filed on Oct. 2, 2001;

U.S. patent application Publication No. 2002-0087363 published on Jul. 4, 2002 to Wahlbin et al., entitled “COMPUTERIZED METHOD AND SYSTEM OF LIABILITY ASSESSMENT FOR AN ACCIDENT USING ENVIRONMENTAL, VEHICLE, AND DRIVER CONDITIONS AND DRIVER ACTIONS” filed on Oct. 2, 2001;

U.S. patent application Publication No. 2002-0091504 published on Jul. 11, 2002 to Wahlbin et al., entitled “COMPUTERIZED METHOD AND SYSTEM FOR ACCUMULATING LIABILITY ESTIMATES” filed on Oct. 2,2001;

U.S. patent application Publication No. 2002-0128881 published on Sep. 12, 2002 to Wahlbin et al., entitled “COMPUTERIZED METHOD AND SYSTEM FOR ADJUSTING LIABILITY ESTIMATES IN AN ACCIDENT LIABILITY ASSESSMENT PROGRAM” filed on Oct. 2, 2001;

U.S. patent application Publication No. 2002-0062232 published on Sep. 12, 2002 to Wahlbin et al., entitled “COMPUTERIZED METHOD AND SYSTEM FOR ADJUSTING LIABILITY ESTIMATION FACTORS IN AN ACCIDENT LIABILITY ASSESSMENT PROGRAM” filed on Oct. 2, 2001;

U.S. patent application Publication No. 2002-0062235 published on May 23, 2002 to Wahlbin et al., entitled “COMPUTERIZED METHOD AND SYSTEM FOR PROVIDING CLAIMS DATA TO AN ACCIDENT LIABILITY ASSESSMENT PROGRAM” filed on Oct. 2, 2001;

U.S. patent application Publication No. 2002-0059084 published on May 16, 2002 to Wahlbin et al., entitled “COMPUTERIZED METHOD AND SYSTEM OF DISPLAYING AN ACCIDENT TYPE” filed on Oct. 2, 2001;

U.S. patent application Publication No. 2002-0059086 published on May 16, 2002 to Wahlbin et al., entitled “COMPUTERIZED METHOD AND SYSTEM OF DISPLAYING A ROADWAY CONFIGURATION RELATING TO AN ACCIDENT” filed on Oct. 2, 2001;

U.S. patent application Publication No. 2002-0059087 published on May 16, 2002 to Wahlbin et al., entitled “COMPUTERIZED METHOD AND SYSTEM OF DISPLAYING AN IMPACT POINT RELATING TO AN ACCIDENT” filed on Oct. 2, 2001;

U.S. patent application Publication No. 2002-0059083 published on May 16, 2002 to Wahlbin et al., entitled “COMPUTERIZED METHOD AND SYSTEM OF DETERMINING INCONSISTENCIES IN WITNESS STATEMENTS RELATING TO

AN ACCIDENT” filed on Oct. 2, 2001;

U.S. patent application Publication No. 2002-0049619 published on Apr. 25, 2002 to Wahlbin et al., entitled “COMPUTERIZED METHOD AND SYSTEM OF IDENTIFYING A CREDIBLE WITNESS STATEMENT RELATING TO AN

ACCIDENT” filed on Oct. 2, 2001;

U.S. patent application Publication No. 2002-0059085 published on May 16, 2002 to Wahlbin et al., entitled “COMPUTERIZED METHOD AND SYSTEM OF DETERMINING A CREDIBLE REAL SET OF CHARACTERISTICS FOR AN

ACCIDENT” filed on Oct. 2, 2001;

U.S. patent application Ser. No. 10/306,864 to Wahlbin et al., entitled “COMPUTERIZED METHOD AND SYSTEM FOR ESTIMATING LIABILITY FOR AN ACCIDENT FROM AN INVESTIGATION OF THE ACCIDENT” filed on Nov. 27, 2002;

U.S. patent application Ser. No. 10/306,873 to Wahlbin et al., entitled “COMPUTERIZED METHOD AND SYSTEM FOR ESTIMATING LIABILITY FOR AN ACCIDENT USING DYNAMIC GENERATION OF QUESTIONS” filed on Nov. 27, 2002;

U.S. patent application Ser. No. 10/306,909 to Wahlbin et al., entitled “COMPUTERIZED METHOD AND SYSTEM FOR ESTIMATING AN EFFECT ON LIABILITY OF THE SPEED OF VEHICLES IN AN ACCIDENT AND TIME AND DISTANCE TRAVELED BY THE VEHICLES” filed on Nov. 27, 2002;

U.S. patent application Ser. No. 10/306,623 to Wahlbin et al., entitled “COMPUTERIZED METHOD AND SYSTEM FOR ESTIMATING AN EFFECT ON LIABILITY USING A COMPARISON OF THE ACTUAL SPEED OF VEHICLES IN AN ACCIDENT AND TIME AND DISTANCE TRAVELED BY THE VEHICLES IN A MERGING VEHICLE ACCIDENT” filed on Nov. 27, 2002;

U.S. patent application Ser. No. 10/306,803 to Wahlbin et al., entitled “COMPUTERIZED METHOD AND SYSTEM FOR ESTIMATING AN EFFECT ON LIABILITY USING A COMPARISON OF THE ACTUAL SPEED OF VEHICLES WITH A SPECIFIED SPEED” filed on Nov. 27, 2002;

U.S. patent application Ser. No. 10/306,908 to Wahlbin et al., entitled “COMPUTERIZED METHOD AND SYSTEM FOR ESTIMATING AN EFFECT ON LIABILITY BASED ON THE STOPPING DISTANCE OF VEHICLES” filed on Nov. 27, 2002;

U.S. patent application Ser. No. 10/306,804 to Wahlbin et al., entitled “COMPUTERIZED METHOD AND SYSTEM FOR ESTIMATING AN EFFECT ON LIABILITY USING CLAIM DATA ACCESSED FROM CLAIM REPORTING SOFTWARE” filed on Nov. 27, 2002;

U.S. patent application Ser. No. 10/306,866 to Wahlbin et al., entitled “COMPUTERIZED METHOD AND SYSTEM FOR CREATING PRE-CONFIGURED CLAIM REPORTS INCLUDING LIABILITY IN AN ACCIDENT ESTIMATED USING A COMPUTER SYSTEM” filed on Nov. 27, 2002;

U.S. patent application Ser. No. 10/306,858 to Wahlbin et al., entitled “COMPUTERIZED METHOD AND SYSTEM FOR ESTIMATING LIABILITY USING RECORDED VEHICLE DATA” filed on Nov. 27, 2002;

U.S. patent application Ser. No. 10/306,628 to Wahlbin et al., entitled “COMPUTERIZED METHOD AND SYSTEM FOR ESTIMATING MONETARY DAMAGES DUE TO INJURIES IN AN ACCIDENT FROM LIABILITY ESTIMATED USING A COMPUTER SYSTEM” filed on Nov. 27, 2002;

U.S. patent application Ser. No. 10/790,632 to Woods et al., entitled “GRAPHICAL INJURY SELECTION” filed on Mar. 1, 2004; and

U.S. patent application Ser. No. 10/790,626 to Lorenz, entitled “SYSTEMS AND METHODS FOR USING DATA STRUCTURE LANGUAGE IN WEB SERVICES” filed on Mar. 1, 2004.

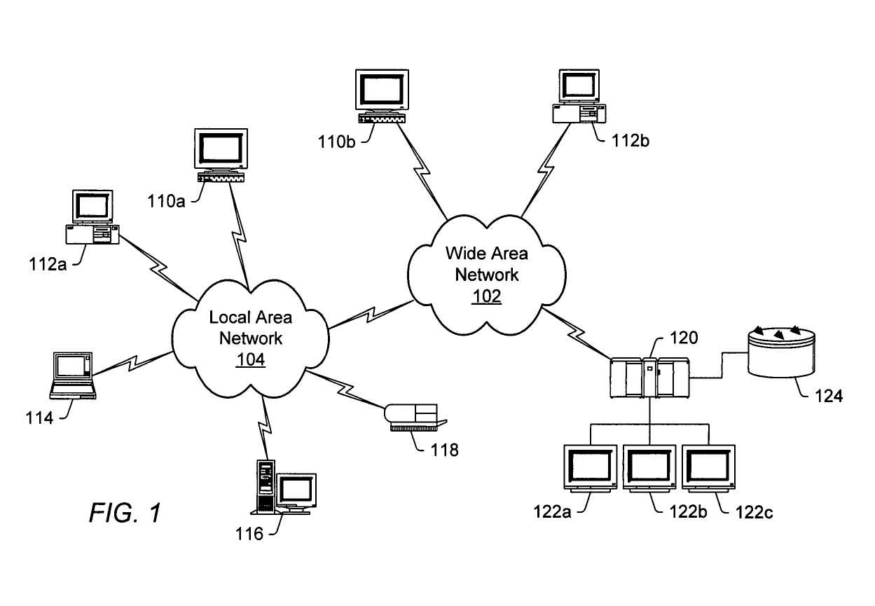

FIG. 1 illustrates an embodiment of a wide area network (“WAN”). WAN 102 may be a network that spans a relatively large geographical area. The Internet is an example of WAN 102. WAN 102 typically includes a plurality of computer systems that may be interconnected through one or more networks. Although one particular configuration is shown in FIG. 1, WAN 102 may include a variety of heterogeneous computer systems and networks that may be interconnected in a variety of ways and that may run a variety of software applications.

One or more local area networks (“LANs”) 104 may be coupled to WAN 102. LAN 104 may be a network that spans a relatively small area. Typically, LAN 104 may be confined to a single building or group of buildings. Each node (i.e., individual computer system or device) on LAN 104 may have its own CPU with which it may execute programs, and each node may also be able to access data and devices anywhere on LAN 104. LAN 104, thus, may allow many users to share devices (e.g., printers) and data stored on file servers. LAN 104 may be characterized by a variety of types of topology (i.e., the geometric arrangement of devices on the network), of protocols (i.e., the rules and encoding specifications for sending data, and whether the network uses a peer-to-peer or user/server architecture), and of media (e.g., twisted-pair wire, coaxial cables, fiber optic cables, and/or radio waves).

Each LAN 104 may include a plurality of interconnected computer systems and optionally one or more other devices such as one or more workstations 110a, one or more personal computers 112a, one or more laptop or notebook computer systems 114, one or more server computer systems 116, and one or more network printers 118. As illustrated in FIG. 1, an example LAN 104 may include one of each computer systems 110a, 112a, 114, and 116, and one printer 118. LAN 104 may be coupled to other computer systems and/or other devices and/or other LANs 104 through WAN 102.

One or more mainframe computer systems 120 may be coupled to WAN 102. As shown, mainframe 120 may be coupled to a storage device or file server 124 and mainframe terminals 122a, 122b, and 122c. Mainframe terminals 122a, 122b, and 122c may access data stored in the storage device or file server 124 coupled to or included in mainframe computer system 120. WAN 102 may also include computer systems connected to WAN 102 individually and not through LAN 104 for purposes of example, workstation 110b and personal computer 112b. For example, WAN 102 may include computer systems that may be geographically remote and connected to each other through the Internet.

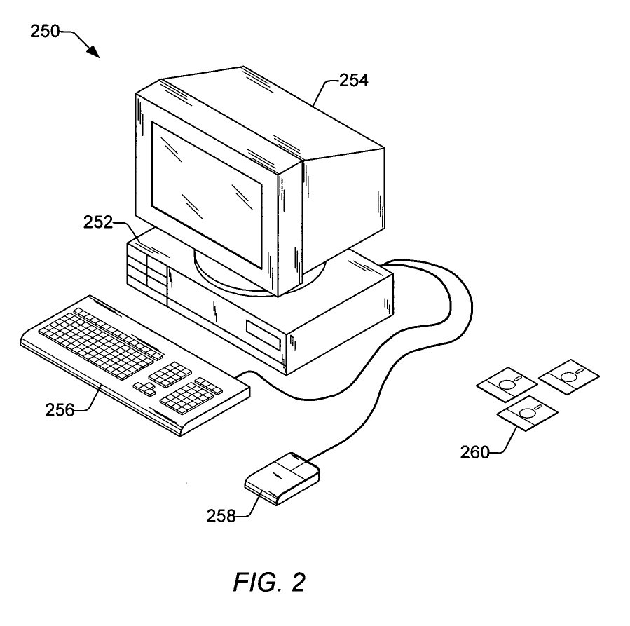

FIG. 2 illustrates an embodiment of computer system 250 that may be suitable for implementing various embodiments of a system and method for diagram data collection. Each computer system 250 typically includes components such as CPU 252 with an associated memory medium such as floppy disks 260. The memory medium may store program instructions for computer programs. The program instructions may be executable by CPU 252. Computer system 250 may further include a display device such as monitor 254, an alphanumeric input device such as keyboard 256, and a directional input device such as mouse 258. Computer system 250 may be operable to execute the computer programs to implement computer-implemented systems and methods for diagram data collection.

Computer system 250 may include a memory medium on which computer programs according to various embodiments may be stored. The term “memory medium” is intended to include an installation medium, e.g., a CD-ROM or floppy disks 260, a computer system memory such as DRAM, SRAM, EDO RAM, Rambus RAM, etc., or a non-volatile memory such as a magnetic media, e.g., a hard drive or optical storage. The memory medium may also include other types of memory or combinations thereof. In addition, the memory medium may be located in a first computer, which executes the programs or may be located in a second different computer, which connects to the first computer over a network. In the latter instance, the second computer may provide the program instructions to the first computer for execution. Computer system 250 may take various forms such as a personal computer system, mainframe computer system, workstation, network appliance, Internet appliance, personal digital assistant (“PDA”), television system or other device. In general, the term “computer system” may refer to any device having a processor that executes instructions from a memory medium.

The memory medium may store a software program or programs operable to implement a method for diagram data collection. The software program(s) may be implemented in various ways, including, but not limited to, procedure-based techniques, component-based techniques, and/or object-oriented techniques, among others. For example, the software programs may be implemented using ActiveX controls, C++ objects, JavaBeans, Microsoft Foundation Classes (“MFC”), browser-based applications (e.g., Java applets), traditional programs, or other technologies or methodologies, as desired. A CPU such as host CPU 252 executing code and data from the memory medium may include a means for creating and executing the software program or programs according to the embodiments described herein.

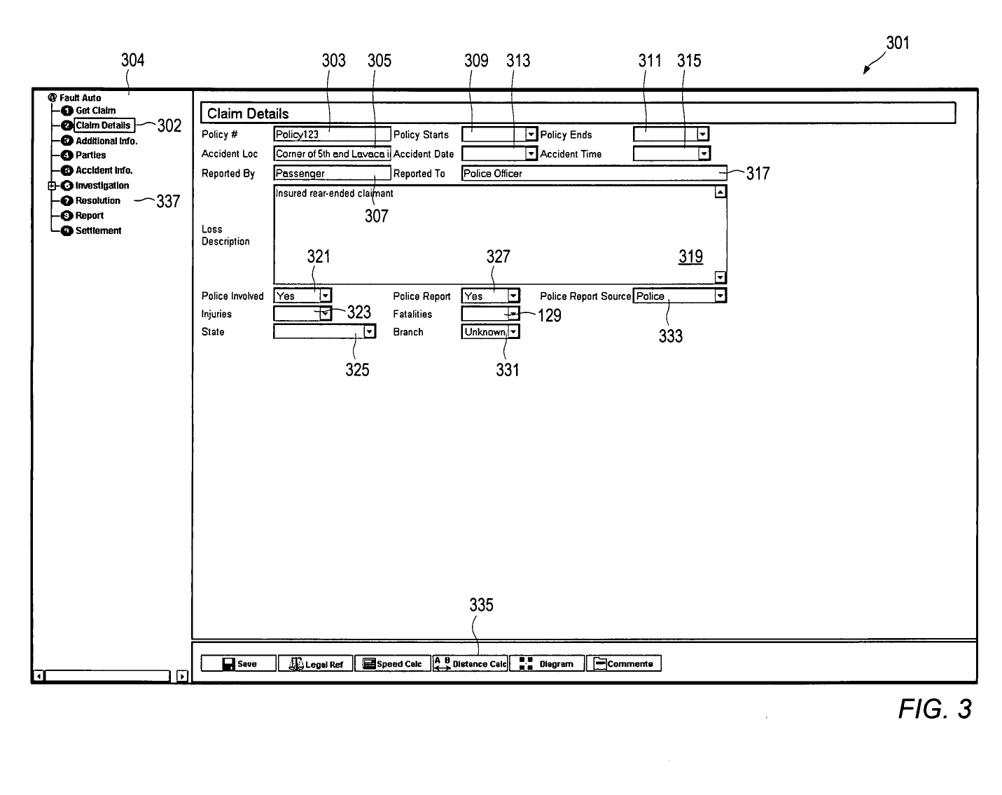

FIG. 3 illustrates an embodiment of a claims details screen. In some embodiments, a claims detail screen 301 may be displayed when a claim details option 302 is selected from a general menu 304. In some embodiments, an application for collecting data may provide general menu 304 and various data collection screens using a web browser. For example, the browser may execute using JavaScript. While several embodiment screens are displayed, it is to be understood that the screen in FIG. 3 and following figures are illustrative of certain embodiments only. Other screens may also be used.

In some embodiments, claim information may include, but is not limited to, policy number 303, accident location 305, reporter 307, policy start date 309, policy end date 311, accident date 313, accident time 315, reported to entity 317, loss description 319, whether police were involved 321, injuries 323, state 325, police report 327, fatalities 329, branch 331, and police report source 333. In some embodiments, answers for inquiries on the data collection screens may be formatted appropriately. For example, if a dollar amount is requested, a dollar sign “$”, commas, and a decimal point may be provided in an answer field. As another example, “mm/dd/yyyy” or “yyyy/mm/dd” may be provided for date entries. In some embodiments, information input into the data collection screens may be restricted in length.

In various embodiments, additional options 335 (e.g., save, legal references, speed calculations, distance calculations, accident diagram, and comments) may also be available, e.g., to assist an insurance claims adjuster in entering data and estimating fault. In some embodiments, a “fast track” option may be available to expedite processing a claim by prompting for fewer inputs. For example, if certain criteria are met (e.g., if the accident type is a rear end accident), the claim may be processed more quickly and with fewer inputs. In some embodiments, the fast track may only be reasonable for accidents such as rear end accidents that are fairly easy to calculate fault using less information than typical accidents. In some embodiments, additional information may be needed for processing (e.g., in more complicated accidents and/or accidents involving more than two vehicles).

In some embodiments, accident information may be entered for each involved entity according to the involved entity's version. For example, a claimant's version of the accident and an insured's version of the accident may be entered and kept separately. In some embodiments, both versions may be considered in a fault calculation. In some embodiments, the versions may be reconciled and a reconciled version may be considered in a fault determination. As used herein an “insured” may be a person or entity insured by an insurance company. A “claimant” may be a person or entity involved in an accident with the insured. In some embodiments, the claimant may file a claim with the insurance company as a result of the accident.

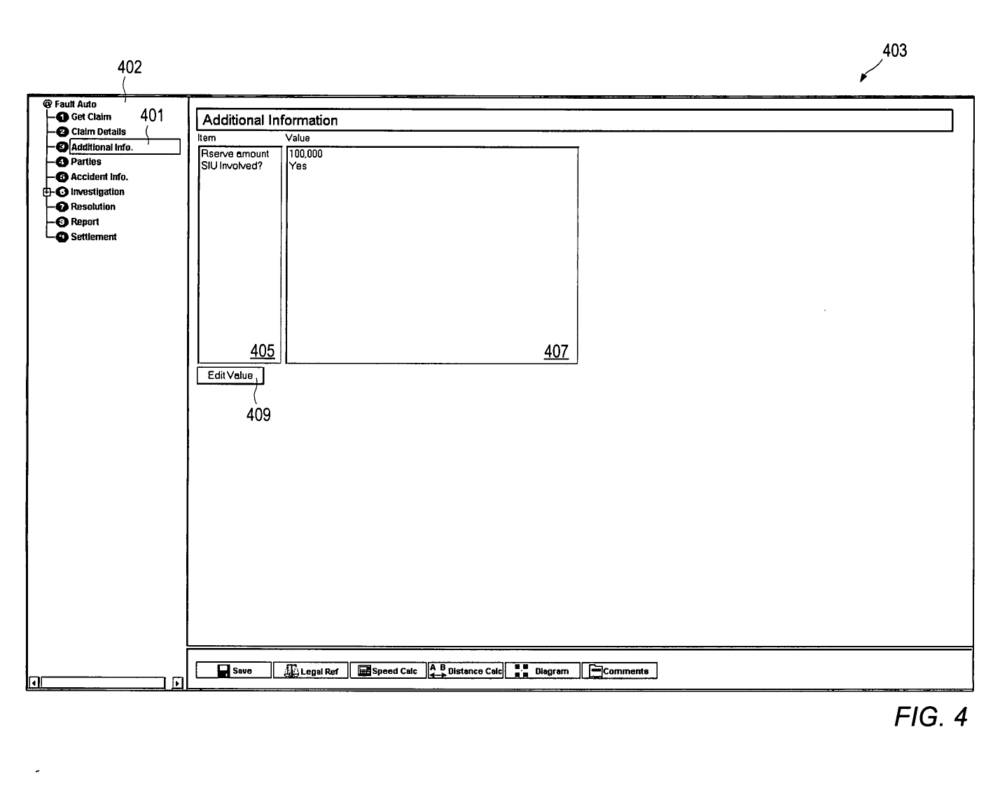

FIG. 4 illustrates an embodiment of an additional information screen. In some embodiments, an additional information screen 403 may be displayed when a user selects an additional information option 401 from a general menu 402. Additional insurance may include, e.g., a reserve amount and whether a special investigative unit (SIU) is involved. In some embodiments, additional information may be entered as an item 405 and value 407 (e.g., a value may be edited using edit value selector 409). The additional information may be stored and/or edited. In some embodiments, custom questions may be defined by entities such as insurance companies, adjusters, special investigative units, etc. for the additional information screen. Additional information may be considered in determining fault or may be used in administration for a claim (e.g., arranging pay out, reports, etc.). For example, the computer system may use additional information to determine fault, or an adjuster may refer to collected information while manually determining fault.

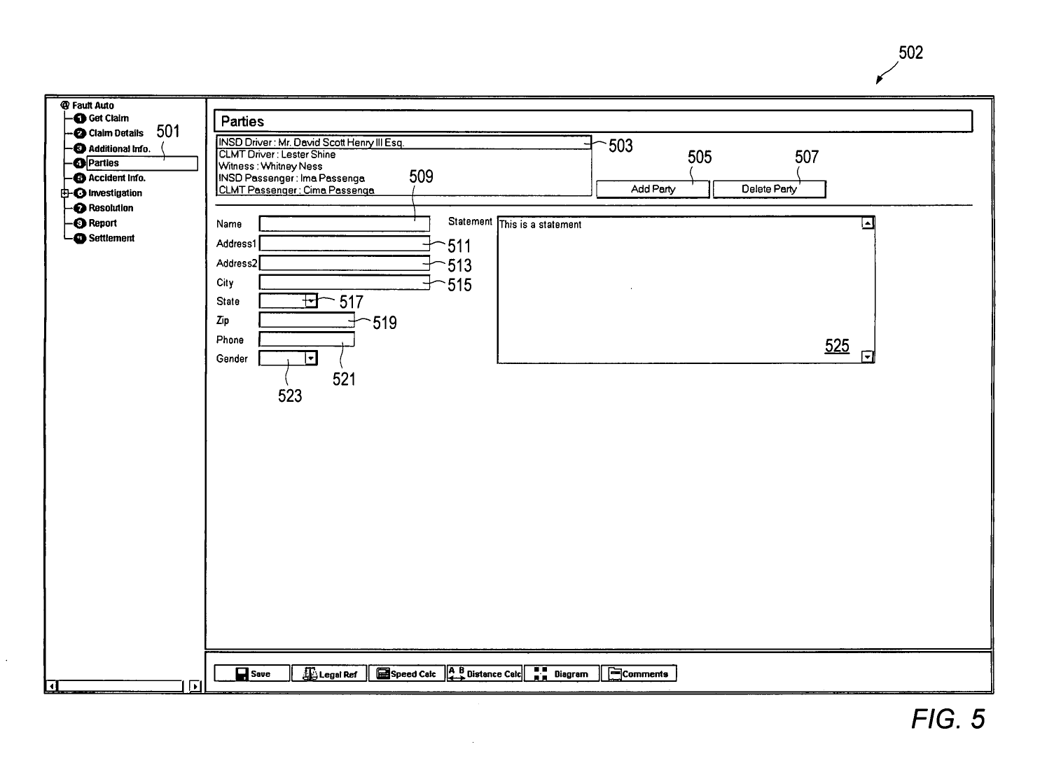

FIG. 5 illustrates an embodiment of a parties information screen. In some embodiments, a parties option 501 may be selected to display a parties information screen 502. In some embodiments, a party may be selected from a list of involved parties 503. In some embodiments, add party button 505 and delete party button 507 may be used to add/delete parties from the list 503. For each party, information including name 509, first address line 511, second address line 513, city 515, state 517, zip code 519, phone number 521, gender 523, and a statement 525 may be entered. In some embodiments, information about parties may be used to track claims, access additional information (e.g., prior accidents), contact information, etc. Additional information about the parties may also be entered. In some embodiments, entered information, including additional information, may be verified. A graphical indicator may be used to indicate portions of the information that have been verified.

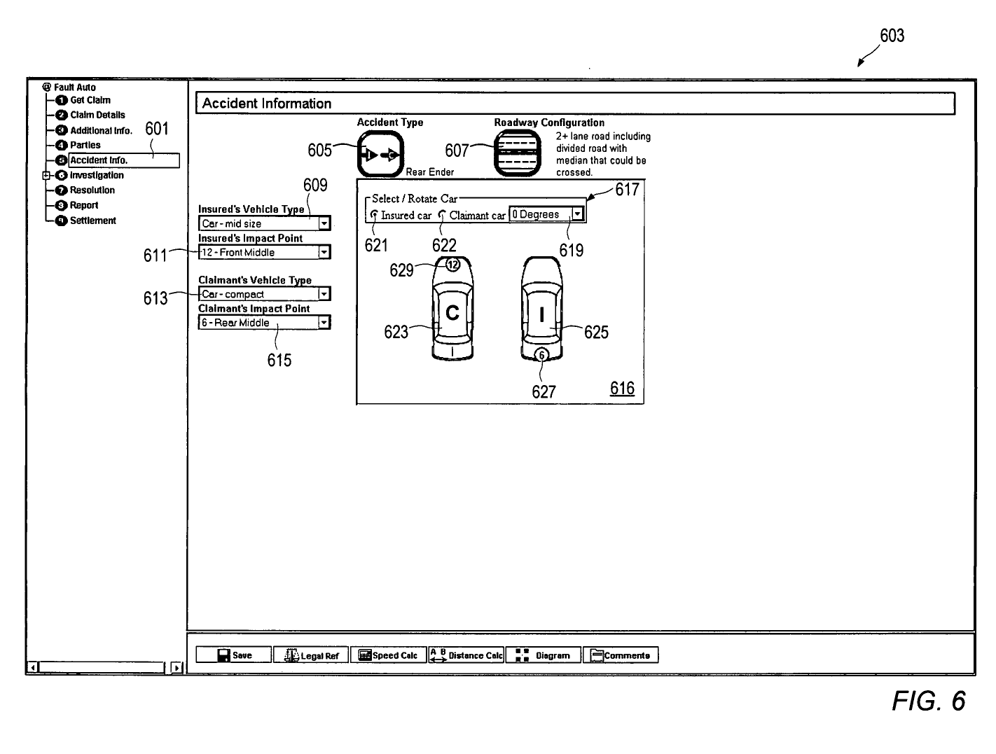

FIG. 6 illustrates an embodiment of an accident information screen. In some embodiments, accident information option 601 may be selected to display accident information screen 603. In some embodiments, accident information may include an insured's vehicle type 609, an insured's impact point 611, a claimant's vehicle type 613, and a claimant's impact point 615. In some embodiments, a vehicle type may be selected from compact car, midsize car, full size car, compact sports utility vehicle (SUV), mid size SUV, full size SUV, mid size truck, full size truck, van, and unknown. In some embodiments, a make and model for an involved vehicle may be entered. In some embodiments, information including accident type 605, roadway configuration 607, and vehicle orientation 616 may also be included. Other information about the accident (e.g., the color of each vehicle involved) may also be entered. In some embodiments, only information needed to determine fault may be entered. In some embodiments, at least a portion of the information may be received from an electronic source. For example, a user's computer may input the information into the system without the user having to reenter the information.

In some embodiments, vehicle orientation 616 may include a select/rotate box 617 to select a vehicle (e.g., radial buttons for the insured vehicle 621 or claimant vehicle 622). In some embodiments, a vehicle may be selected and rotated using a drop down menu 619 of orientations. In some embodiments, graphical vehicles 623, 625 may be rotated in 45 degree increments. In some embodiments, other increments may be used, for example, a vehicle may be rotated in one degree increments. In some embodiments, a vehicle may be rotated by entering a rotation value in an input box (not shown). In some embodiments, a vehicle may be right clicked and a rotation value may be selected from a drop down menu that appears. In some embodiments, a vehicle may be selected, and a user may click (e.g., using a mouse pointer) in the direction the front of the selected vehicle should face (e.g., on a compass graphic). In some embodiments, a circular arrow graphic may be selected and the vehicle may be rotated in a motion corresponding to a mouse motion or arrow keys on a keyboard (e.g., the circular arrow graphic may be located just outside of a vehicle graphic). In some embodiments, a drop down menu, input box, circular graphic, or other graphic to enter a rotation value may remain visible and accessible after a rotation is selected or may be hidden after a rotation is selected. In some embodiments, the vehicle may be moved in addition to being rotated. The location and rotation of the vehicle may be stored in a database to assist in a fault determination.

In some embodiments, a graphical representation of the insured's vehicle 623 may include the insured's impact point 629 and the claimant's vehicle 625 may include the claimant's impact point 627. In some embodiments, when an impact point is selected for each vehicle, the vehicles may be automatically arranged with the two impact points in contact. In some embodiments, the two vehicles may then be rotated together. In some embodiments, an impact point may be designated for a point on the vehicle where the vehicle made contact with an object (e.g., a telephone pole). In some embodiments, the graphical representation may match the type of vehicle entered for each involved party (e.g., an “SUV” for the claimant and a “van” for the insured). In some embodiments, the graphical representation may also be the same color as the involved vehicle it represents. In some embodiments, a graphical representation of the vehicle may be representative of the entered vehicle type. In some embodiments, a scanned in image of the vehicle (e.g., a top down view) may be used to represent the vehicle. In some embodiments, an image of the actual wrecked vehicle may be used. In some embodiments, colors may be used to designate the type of vehicles (e.g., red for claimant and blue for the insured). In some embodiments, a label on each vehicle may indicate the claimant's (e.g., “C”) vehicle and the insured's (e.g., “I”) vehicle. In some embodiments, the label may stay upright relative to the screen and not rotate as the vehicle is rotated. In some embodiments, an impact point (e.g., impact point 627) label on the vehicle may stay upright relative to the screen and not rotate as the vehicle is rotated. In some embodiments, multiple impact point labels on a vehicle may remain upright as the vehicle is rotated.

In various embodiments, multiple vehicles may be considered. For example, data may be entered on three involved vehicles. In some embodiments, designations (e.g., “C1” and “C2”) may be used for each of the multiple vehicles. In some embodiments, multiple impact points may also be used and designated. In addition, impact points may be designated according to the opposing vehicle that was involved in the impact.

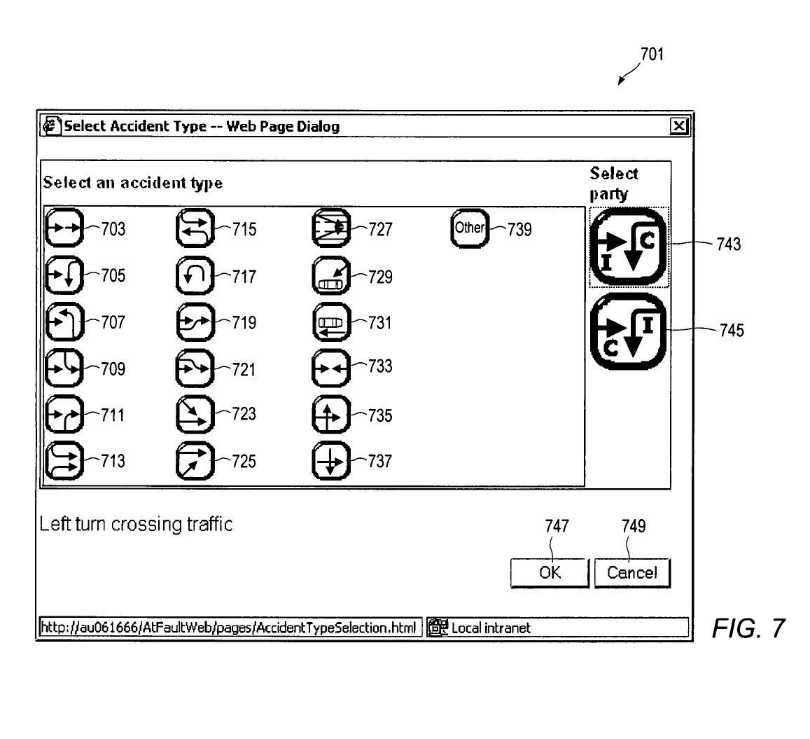

FIG. 7 illustrates an embodiment of an accident type selection screen. In some embodiments, an accident type 605 may be selected from a list of accident types 701. For example, an accident type may include rear ender 703, left turn crossing traffic 705, left turn across traffic 707, left turn entering traffic 709, right turn entering traffic 711, dual turn to same lane 713, concurrent left turns 715, u-turn 717, parked merging into traffic from right 719, parked merging into traffic from left 721, lane change or merge from left 723, lane change or merge from right 725, lane change or merge to single lane 727, collision with parked vehicle 729, backing 731, head on 733, straight across traffic with one vehicle traveling to the right and the other vehicle traveling upward 735, straight across traffic with one vehicle traveling to the right and the other vehicle traveling downward 737, and other 739. In some embodiments, other types of accidents may also be considered (e.g., a dual backing accident may occur when two vehicles back into each other). In some embodiments, parties may be selected from two relative selections 743 and 745 (which may change depending on the accident type selected). In some embodiments, a selection may be confirmed 747 or cancelled 749. In some embodiments, when an accident type is selected, vehicles displayed in the accident information screen may be oriented according to the accident type. In some embodiments, a user may be able to move the vehicles within a limited amount after an accident type is selected.

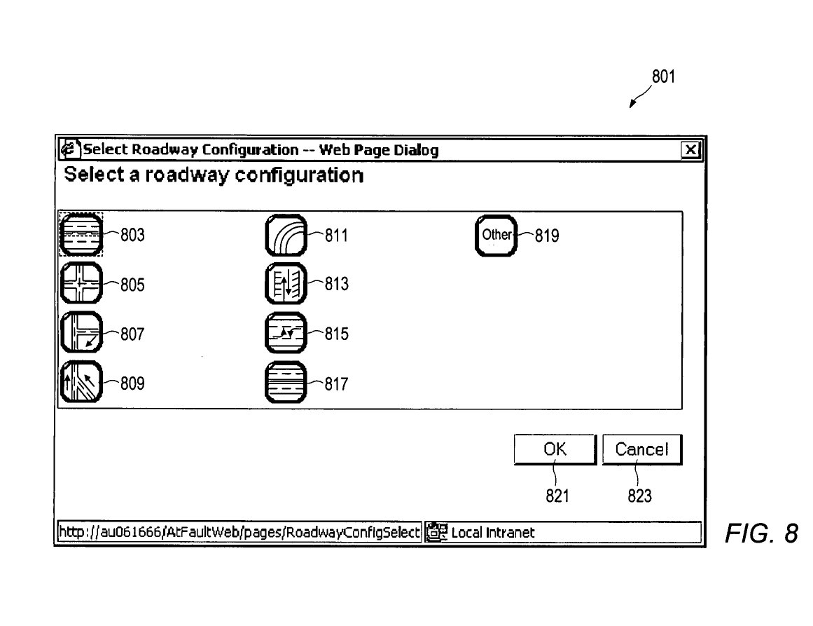

FIG. 8 illustrates an embodiment of a roadway configuration selection screen 801. In some embodiments, a roadway configuration 607 may include two lane road with median that could be crossed 803, four way intersection 805, T-intersection 807, Y intersection 809, curve 811, parking lot aisle 813, center turn lane 815, over two lane road with median that cannot be crossed 817, and other 819. A selection may be confirmed 821 or cancelled 823. In some embodiments, a roadway may be dynamically built according to user input. For example, a user may be prompted for information such as a number of lanes, number and type of stripes, a color of the stripes on the road. Other information may also be entered. A roadway matching the entered information may be constructed graphically based on the entered information.

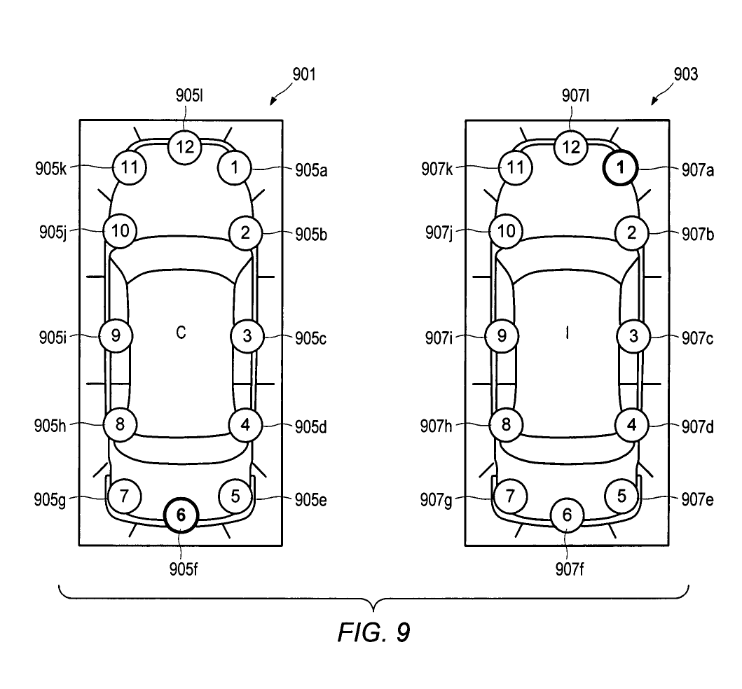

FIG. 9 illustrates an embodiment of two vehicles and two sets of impact points. In some embodiments, a claimant's vehicle 901 may have impact points including right front corner 905a, right fender 905b, right middle 905c, right quarter panel 905d, right rear corner 905e, rear middle 905f, left rear corner 905g, left quarter panel 905h, left middle 905i, left fender 905j, left front corner 905k, and front middle 905l. An insured's vehicle 903 may have similar potential impact points 907a-i. In various embodiments, more or fewer impact points may be available. In some embodiments, an impact point displayed on a vehicle may be the color of the other vehicle involved in the impact (i.e., that was a source of the impact). In some embodiments, multiple colors may be used for multiple impact points involving multiple vehicles (e.g., with each impact point matching the color of the opposing vehicle involved in the impact).

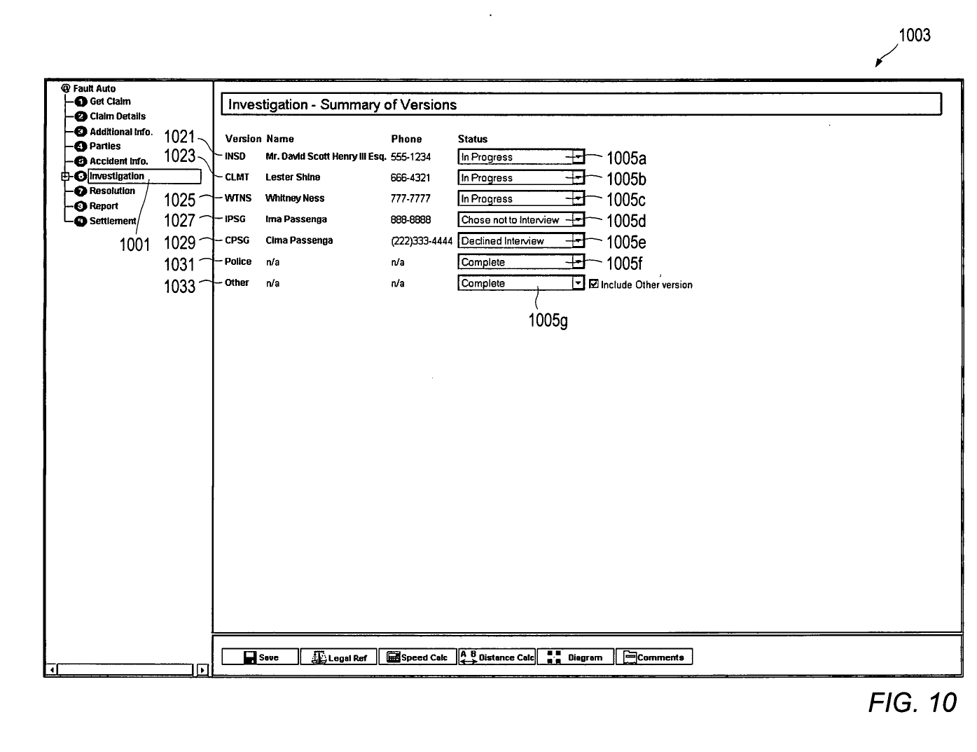

FIG. 10 illustrates an embodiment of an investigation summary information screen. In some embodiments, an investigation summary information screen 1003 may be displayed when an investigation option 1001 is selected. In some embodiments, investigation summary information may include information from an insured 1021, a claimant 1023, a witness 1025, passengers 1027 and 1029, a police officer 1031 and other 1033. In some embodiments, status indicators 1005 may be selected from drop down menus near the listed sources. For example, “In Progress” 1005a-c, “chose not to interview” 1005d, “declined interview” 1005e, “Unable to contact”, “Awaiting Contact”, and “Complete” 1005f-g may be provided as options.

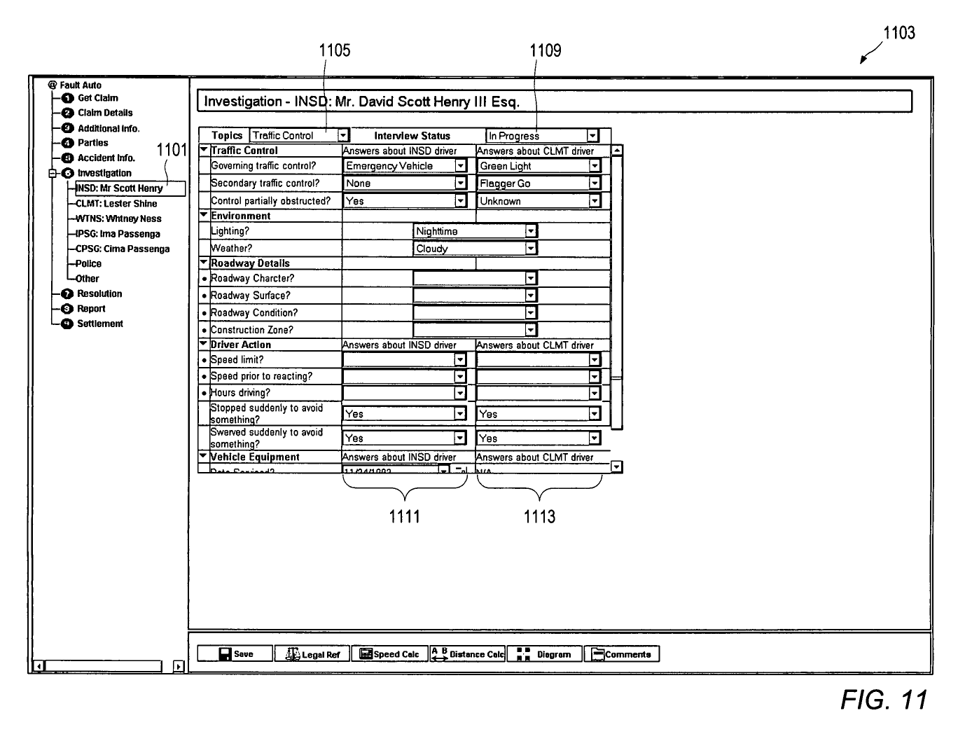

FIG. 11 illustrates an embodiment of an investigation information screen 1103 for an involved party. In some embodiments, specific investigation information may be displayed for an involved party (e.g., insured 1101). In some embodiments, different type of questions may be presented depending on a chosen topic 1105. For example information about traffic controls, the environment, roadway details, driver actions and vehicle equipment may be included for different view points (e.g., answers about the insured 1111 and answers about the claimant 1113 may be presented). In some embodiments, a status of the interview 1109 may also be selected.

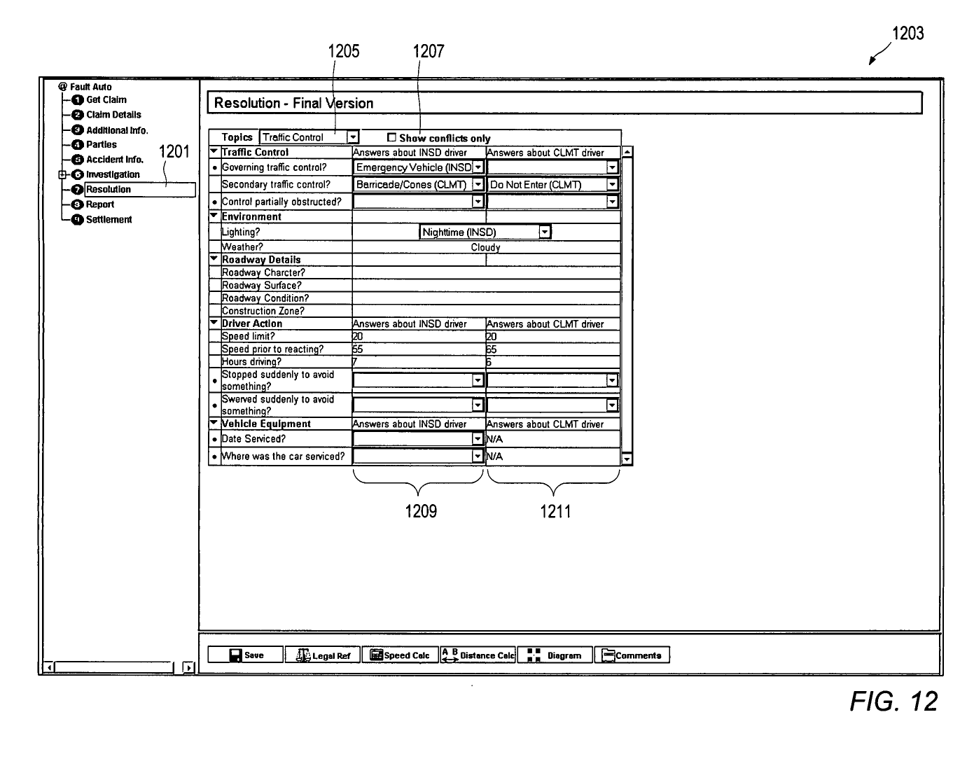

FIG. 12 illustrates an embodiment of a resolution information screen 1203. In some embodiments, resolution information may be displayed when a resolution option 1201 is selected. In some embodiments, different types of information may be presented depending on a chosen topic 1205. For example, information about the insured 1209 and about the claimant 1211 may be presented. In some embodiments, a conflicts indicator 1207 may be selected to highlight conflicting information. Information on a resolution information screen 1203 may be used to resolve conflict between versions and create a resolved version. In some embodiments, the adjuster may use information from involved parties (e.g., information entered in the investigation information screen 1103) to determine which version of an accident the adjuster will use for fault determination. In some embodiment, information previously entered may be displayed on the resolution information screen 1203 for selection by the adjuster.

In some embodiments, the adjuster may enter a new value for an issue on the resolution information screen 1203 (e.g., if the adjuster does not believe any of the witness's answers). In some embodiments, the adjuster may also enter their own answers on the investigation information screen 1103 by entering information for an “Other” version and setting an “Other Source” value to “Adjuster.” In some embodiments, information entry for different versions may be provided on the investigation information screen 1103, while the resolution information screen 1203 may be restricted to choosing which provided version will be used to determine fault. In some embodiments, the adjuster may enter a comment to explain why they are entering their own answer.

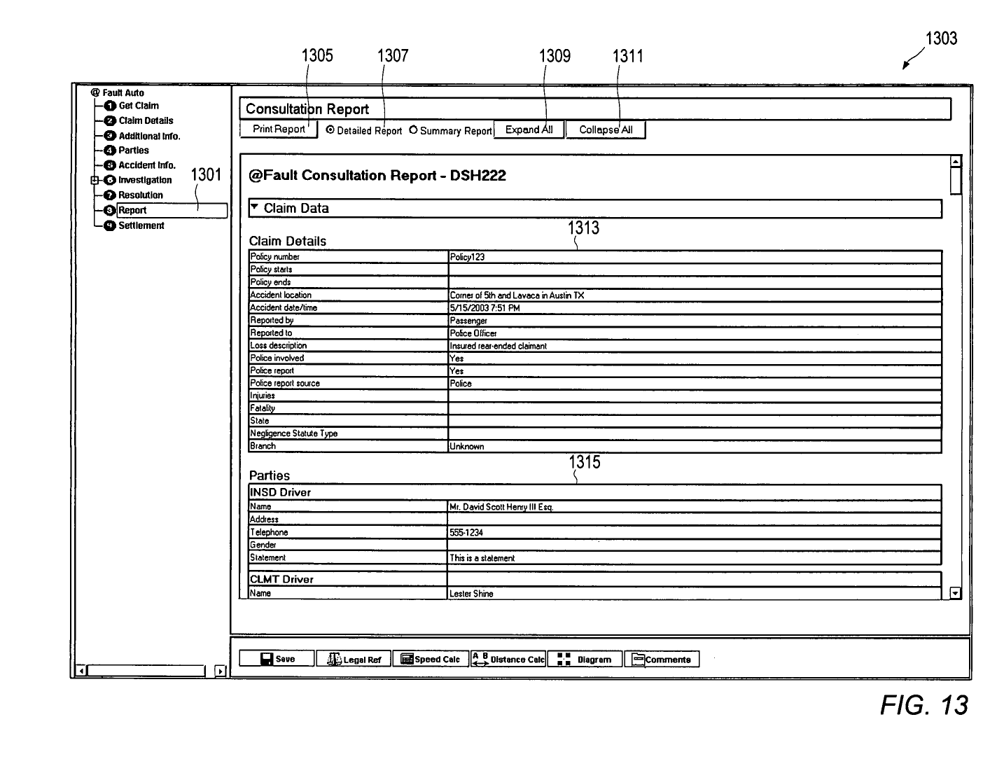

FIG. 13 illustrates an embodiment of a consultation report screen. In some embodiments, a consultation report screen 1303 may be displayed when a report option 1301 is selected. In some embodiments, a consultation report including claim details 1313 and details about the parties 1315 may be displayed. Other information (e.g., other information collected in the data collection screens) may also be displayed in the consultation report. In some embodiments, a level of detail 1307 may be selected including expand all 1309 and collapse all 1311 versions. In some embodiments, a report may be printed 1305. The report may be used by users involved in investigating the accident. The report may also be reviewed by an adjustor or an attorney involved in a case resulting from the accident.

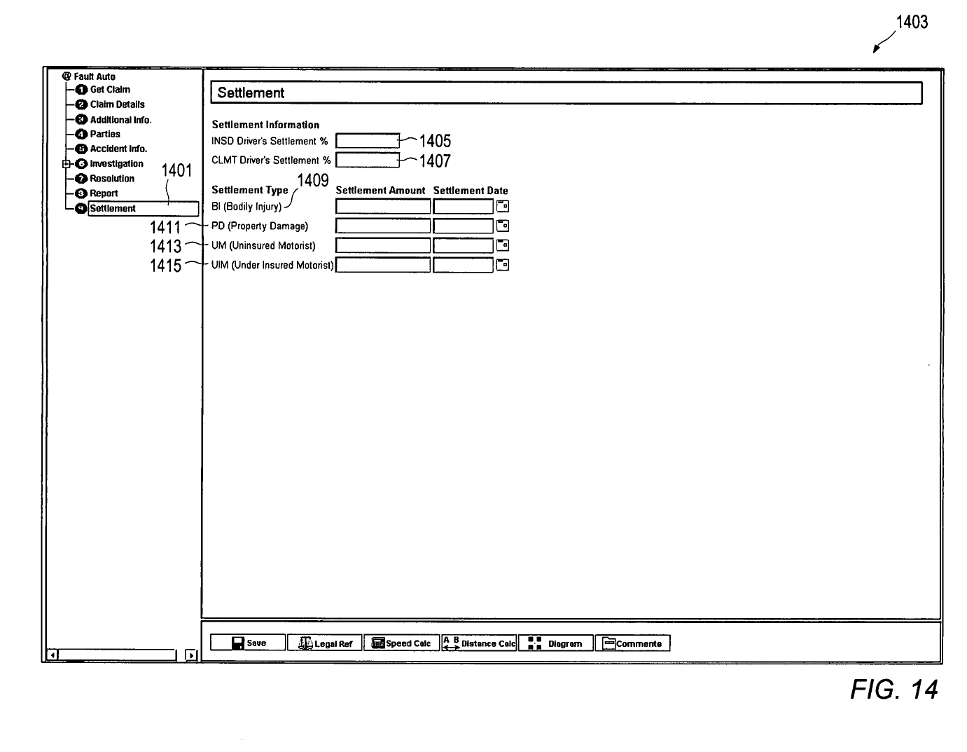

FIG. 14 illustrates an embodiment of a settlement information screen. In some embodiments, a settlement information screen 1403 may be presented when a settlement option 1401 is selected. In some embodiments, an insured's settlement percentage 1405 and a claimant's settlement percentage 1407 may be entered. In some embodiments, the settlement percentage may be the percentage the insured and claimant are each found at fault. In some embodiments, the percentage may be adjusted according to other factors. In some embodiments, information for a bodily injury 1409, property damage 1411, uninsured motorist 1413, and under insured motorist 1415 may be presented including settlement amounts and settlement dates.

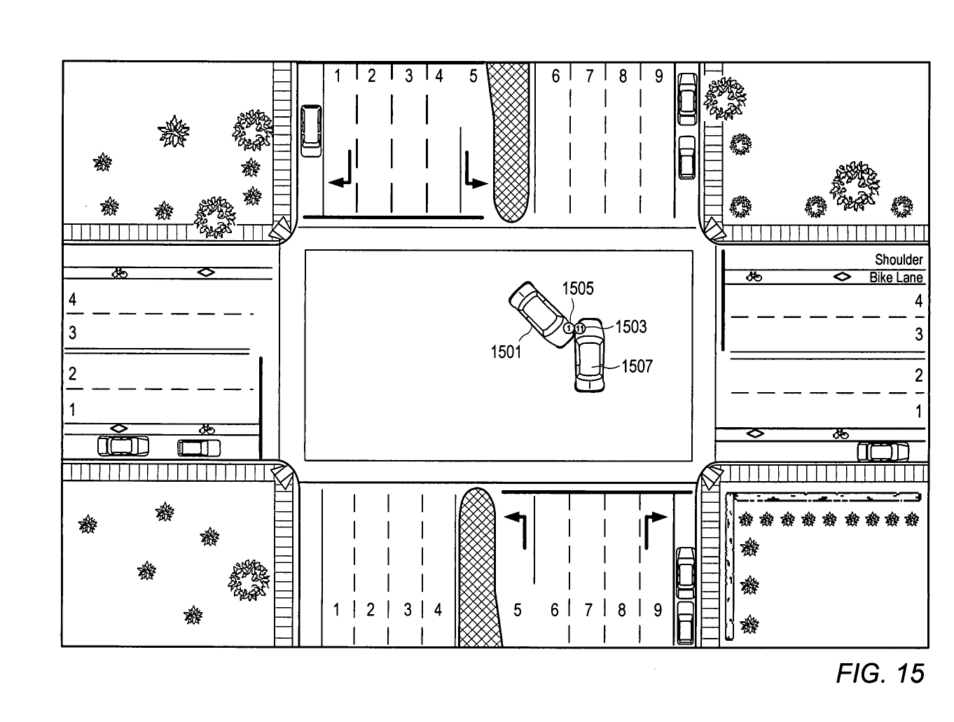

FIG. 15 illustrates a first embodiment of a graphically reported accident. In some embodiments, an accident screen may be displayed with a selected roadway configuration. In some embodiments, one or more vehicles 1501, 1507 may be displayed and oriented relative to each other on the roadway configuration displayed. Impact points 1503, 1505 may be selected by a user or automatically by a system once the vehicle positions are approximated. In some embodiments, the position and rotation of the vehicles may be stored in a database for use in a fault calculation. In some embodiments, these images could also be redisplayed in a report (e.g., the consultation report).

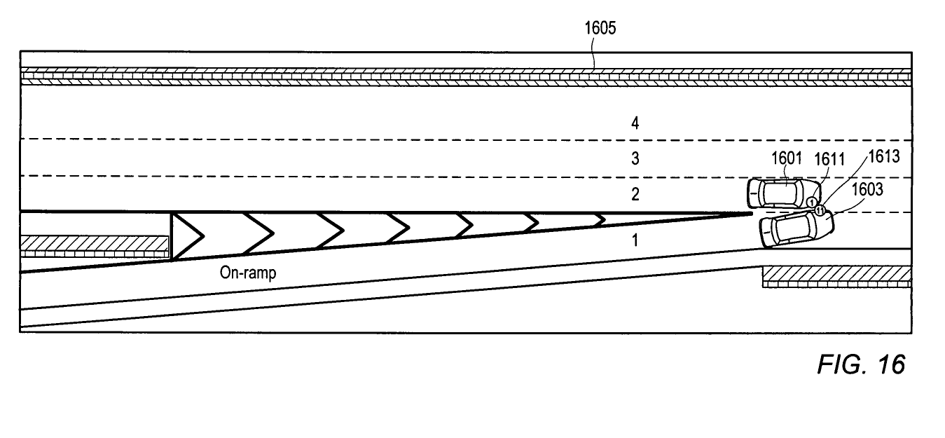

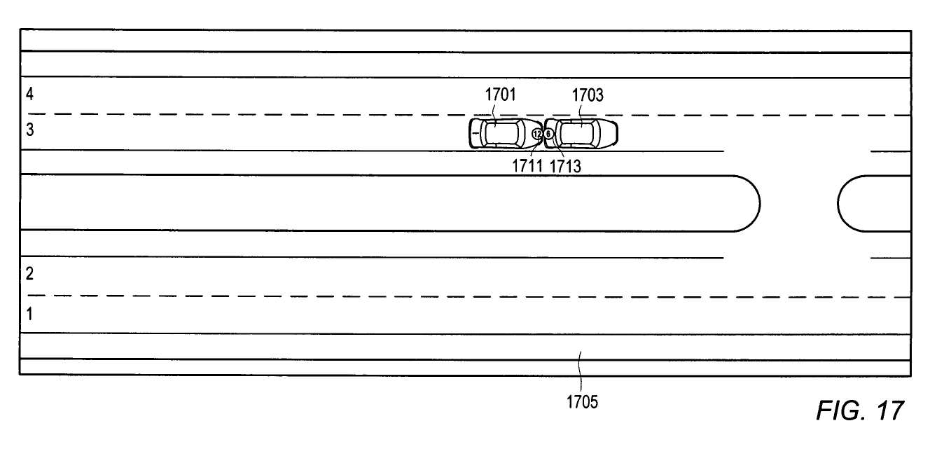

FIG. 16 illustrates a second embodiment of a graphically reported accident. In an embodiment, two vehicles 1601, 1603 may be displayed merging on a freeway and impacting at impact points 1611, 1613. FIG. 17 illustrates a third embodiment of a graphically reported accident. In an embodiment, two vehicles 1701, 1703 may be displayed on a four lane divided highway in a rear end accident. In some embodiments, scanned in pictures of the roadway may also be used. Images of the vehicles may be manipulated on top of the scanned in picture of the roadway where an accident occurred. In some embodiments, digital video or satellite images of the roadway may be used. In some embodiments, global positioning system (GPS) coordinates may be used to place vehicles spatially (e.g., GPS coordinates may be used in conjunction with satellite images). In some embodiments, GPS coordinates may also be used to place impact points 1711, 1713.

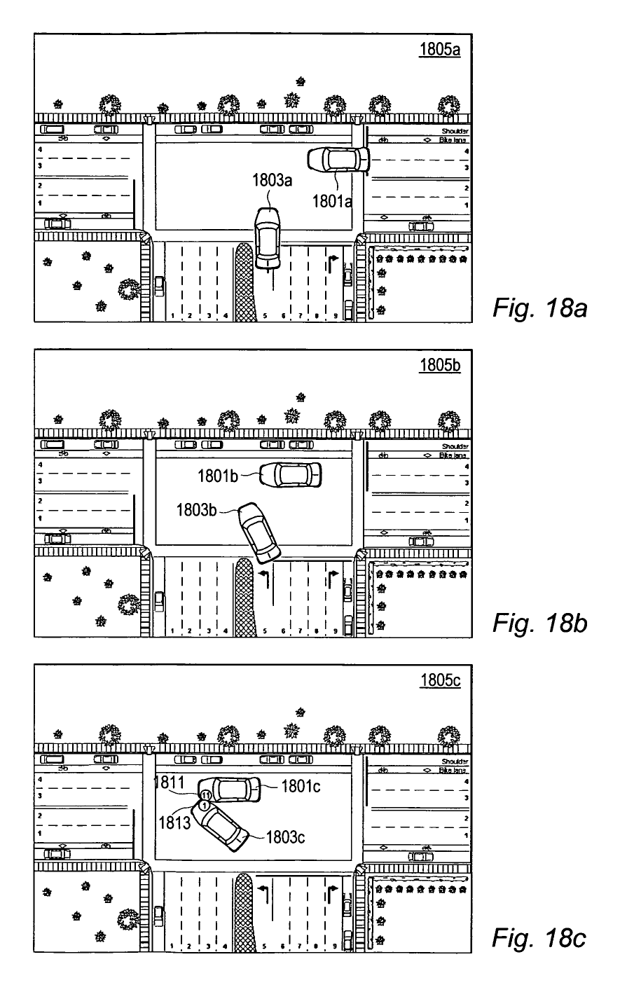

FIGS. 18a, 18b, and 18c illustrate embodiments including snapshots of an accident at three points in time. In some embodiments, involved vehicles may be positioned in multiple snapshots. For example, vehicles 1801a, 1801b, and 1801c may show an involved vehicle at three points in time on roadway 1805. The other vehicle 1803a, 1803b, and 1803c may be shown at its position in those three points in time. Impact points 1811, 1813 may be shown in a single snapshot or in multiple snapshots. Descriptive text may be added to one or more of the snapshots. In some embodiments, the position data for the three points in time may be used for determining fault calculations. In some embodiments, more or fewer snapshots may be used. In some embodiments, the accident may be animated (i.e., displaying the snapshot positionings of the vehicles in chronological sequence).

In some embodiments, custom questions may be added to any of the above data collection screens. For examples, questions related to a topic (e.g., claim data) may be placed close to other questions related to that topic (e.g., on the claim data screen). In some embodiments, the custom questions may be directed towards an adjuster. In some embodiments, custom questions may be added to the investigation information screen for an adjuster to add additional information.

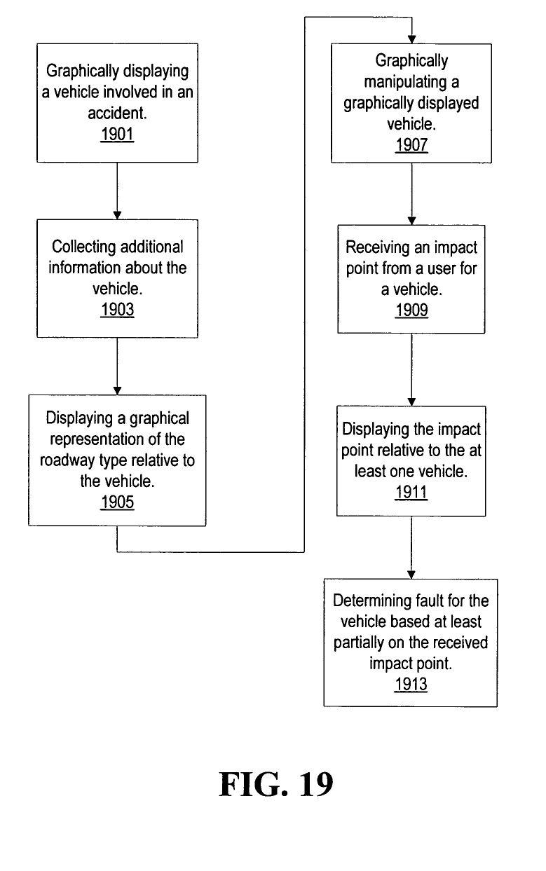

In some embodiments, additional information may be added to data collection screens, e.g., to assist adjusters. In some embodiments, read-only questions (i.e., with no input control for accepting answers) may be displayed to adjusters to communicate messages to the adjuster. For example, additional information may describe the process to complete a fault determination. FIG. 19 illustrates a flowchart of an embodiment for determining fault in a vehicle accident.

At 1901, at least one vehicle involved in an accident may be graphically displayed. For example the at least one vehicle may be displayed on a plain display or on a roadway configuration. At 1903, additional information about the vehicle may be collected. For example, information about a vehicle type, vehicle color, accident type, and roadway type may be collected. At 1905, a graphical representation of the roadway type may be displayed relative to the vehicle. For example, graphical representations of the vehicle's involved may be displayed over the graphical representation of the roadway type. At 1907, a graphically displayed vehicle may be graphically manipulated. In some embodiments, the vehicle representations may be moved and rotated to position the vehicles in a position corresponding to their positions at the time of the accident. In some embodiments, the vehicle representations may be manipulated over a graphical representation of the roadway. At 1909, an impact point may be received from a user for a vehicle. In some embodiments, the impact point may be clicked on a graphical representation using a cursor (e.g., using a mouse or arrow keys). In some embodiments, the impact point may be entered using a drop down menu or an input box. For example, a standard numbering system for different impact point positions may be used. At 1911, an impact point may be displayed relative to the vehicle. In some embodiments, an impact point may be displayed as a circled number on the vehicle. In some embodiments, the impact point may be at least partially a color similar to the color of the other vehicle involved in the impact. At 1913, fault may be determined for a vehicle based at least partially on the received impact point.

Various embodiments may also include receiving or storing instructions and/or data implemented in accordance with the foregoing description upon a carrier medium. Suitable carrier media may include storage media or memory media such as magnetic or optical media, e.g., disk or CD-ROM, as well as signals such as electrical, electromagnetic, or digital signals, may be conveyed via a communication medium such as a network and/or a wireless link.

In this patent, certain U.S. patents, U.S. patent applications, and other materials (e.g., articles) have been incorporated by reference. The text of such U.S. patents, U.S. patent applications, and other materials is, however, only incorporated by reference to the extent that no conflict exists between such text and the other statements and drawings set forth herein. In the event of such conflict, then any such conflicting text in such incorporated by reference U.S. patents, U.S. patent applications, and other materials is specifically not incorporated by reference in this patent.

Further modifications and alternative embodiments of various aspects of the invention may be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

1. A method for determining fault in an accident using a computer, comprising:
graphically displaying at least one vehicle involved in an accident;
graphically manipulating at least one graphically displayed vehicle;
receiving an impact point from a user for at least one displayed vehicle; and
determining fault for at least one displayed vehicle based at least partially on the received impact point.

2. The method of claim 1, further comprising collecting additional information about at least one displayed vehicle.

3. The method of claim 2, wherein the additional information includes an accident type.

4-6. (canceled)

7. The method of claim 2, wherein the additional information includes a roadway type.

8. (canceled)

9. The method of claim 7, further comprising displaying a graphical representation of the roadway type relative to at least one displayed vehicle.

10. The method of claim 9, further comprising displaying at least one vehicle over the representation of the roadway.

11. (canceled)

12. The method of claim 2, wherein additional information includes a vehicle type.

13-21. (canceled)

22. The method of claim 2, wherein the additional information is collected from at least two sources.

23. The method of claim 2, wherein a user enters a numerical value to represent an orientation of at least one displayed vehicle.

24-25. (canceled)

26. The method of claim 1, wherein the impact point is displayed using at least one color that is similar to a color used for displaying at least one other displayed vehicle involved in the accident.

27. The method of claim 1, further comprising graphically manipulating at least one displayed vehicle to resemble an approximate positioning of at least one displayed vehicle during an impact.

28. The method of claim 27, wherein the impact points are selected by the computer based on the user's positioning of at least one displayed vehicle.

29. The method of claim 27, wherein at least one displayed vehicle is manipulated by clicking a mouse pointer on at least one displayed vehicle and rotating at least one displayed vehicle using the mouse.

30. The method of claim 27, wherein at least one displayed vehicle is selected to be manipulated by selecting a radio button respective to at least one displayed vehicle.

31. The method of claim 27, wherein at least one displayed vehicle is rotated by clicking on a graphic.

32. The method of claim 27, wherein a menu provides at least two options for an orientation of at least one displayed vehicle.

33. The method of claim 27, wherein a graphic is displayed over at least one displayed vehicle and the orientation of the displayed vehicle is selected by selecting a point on the graphic.

34. The method of claim 27, further comprising displaying an orientation graphic relative to at least one displayed vehicle, wherein a user uses arrow keys on a keyboard to rotate at least one displayed vehicle.

35. The method of claim 1, wherein at least two displayed vehicles are graphically attached at a respective impact point.

36. The method of claim 35, wherein the displayed vehicles are graphically rotatable as a whole to position the displayed vehicles relative to an accident.

37. The method of claim 1, further comprising receiving at least two positionings of at least one displayed vehicle.

38. The method of claim 37, wherein the at least two positionings are received respective to a time comprised of at least one of before the impact, during the impact, and after the impact.

39. The method of claim 37, further comprising displaying at least two positionings of at least one displayed vehicle in a chronological sequence.

40. (canceled)

41. The method of claim 1, wherein the impact point comprises at least one of right front corner, right fender, right middle, right quarter panel, right rear corner, rear middle, left rear corner, left quarter panel, left middle, left fender, left front corner, and front middle.

42. The method of claim 1, further comprising:
collecting a roadway type and an accident type;
establishing bounds based on the roadway type and accident type for the user to graphically position at least one displayed vehicle.

43. The method of claim 1, further comprising labeling at least one displayed vehicle as an insured's vehicle or as a claimant's vehicle.

44. The method of claim 43, wherein the label is in an upright position regardless of the positioning of the labeled vehicle.

45. The method of claim 1, wherein an impact point is represented by a point label, wherein the point label is displayed respective to at least one displayed vehicle in an upright position regardless of the positioning of at least one displayed vehicle.

46. The method of claim 1, wherein an impact point is displayed respective to at least one displayed vehicle with at least partially a color that resembles a color of a displayed vehicle involved in the accident.

47. The method of claim 1, wherein the graphical manipulation includes moving the graphical displayed vehicle and rotating the graphically displayed vehicle.

48. (canceled)

49. A system, comprising:
a computer program;
a computer system; and
wherein the computer program is executable on the computer system to execute a method of:
graphically displaying at least one vehicle involved in an accident;
graphically manipulating at least one graphically displayed vehicle;
receiving an impact point from a user for at least one displayed vehicle; and
determining fault for at least one displayed vehicle based at least partially on the received impact point.

50. The system of claim 49, further comprising collecting additional information about at least one displayed vehicle.

51. The system of claim 50, wherein the additional information includes an accident type.

52-54. (canceled)

55. The system of claim 50, wherein the additional information includes a roadway type.

56. (canceled)

57. The system of claim 55, further comprising displaying a graphical representation of the roadway type relative to at least one displayed vehicle.

58. The system of claim 57, further comprising displaying at least one vehicle over the representation of the roadway.

59. (canceled)

60. The system of claim 50, wherein additional information includes a vehicle type.

61-69. (canceled)

70. The system of claim 50, wherein the additional information is collected from at least two sources.

71. The system of claim 50, wherein a user enters a numerical value to represent an orientation of at least one displayed vehicle.

72-73. (canceled)

74. The system of claim 49, wherein the impact point is displayed using at least one color that is similar to a color used for displaying at least one other displayed vehicle involved in the accident.

75. The system of claim 49, further comprising graphically manipulating at least one displayed vehicle to resemble an approximate positioning of at least one displayed vehicle during an impact.

76. The system of claim 75, wherein the impact points are selected by the computer based on the user's positioning of at least one displayed vehicle.

77. The system of claim 75, wherein at least one displayed vehicle is manipulated by clicking a mouse pointer on at least one displayed vehicle and rotating at least one displayed vehicle using the mouse.

78. The system of claim 75, wherein at least one displayed vehicle is selected to be manipulated by selecting a radio button respective to at least one displayed vehicle.

79. The system of claim 75, wherein an at least one displayed vehicle is rotated by clicking on a graphic.

80. The system of claim 75, wherein a menu provides at least two options for an orientation of at least one displayed vehicle.

81. The system of claim 75, wherein a graphic is displayed over at least one displayed vehicle and the orientation of the displayed vehicle is selected by selecting a point on the graphic.

82. The system of claim 75, further comprising displaying an orientation graphic relative to at least one displayed vehicle, wherein a user uses arrow keys on a keyboard to rotate at least one displayed vehicle.

83. The system of claim 49, wherein at least two displayed vehicles are graphically attached at a respective impact point.

84. The system of claim 83, wherein the displayed vehicles are graphically rotatable as a whole to position the displayed vehicles relative to an accident.

85. The system of claim 49, further comprising receiving at least two positionings of at least one displayed vehicle.

86. The system of claim 49, wherein the at least two positionings are received respective to a time comprised of at least one of before the impact, during the impact, and after the impact.

87. The system of claim 85, further comprising displaying at least two positionings of at least one displayed vehicle in a chronological sequence.

88. (canceled)

89. The system of claim 49, wherein the impact point comprises at least one of right front corner, right fender, right middle, right quarter panel, right rear corner, rear middle, left rear corner, left quarter panel, left middle, left fender, left front corner, and front middle.

90. The system of claim 49, further comprising:
collecting a roadway type and an accident type;
establishing bounds based on the roadway type and accident type for the user to graphically position at least one displayed vehicle.

91. The system of claim 49, further comprising labeling at least one displayed vehicle as an insured's vehicle or as a claimant's vehicle.

92. The system of claim 91, wherein the label is in an upright position regardless of the positioning of the labeled vehicle.

93. The system of claim 49, wherein an impact point is represented by a point label, wherein the point label is displayed respective to at least one displayed vehicle in an upright position regardless of the positioning of at least one displayed vehicle.

94. The system of claim 49, wherein an impact point is displayed respective to at least one displayed vehicle with at least partially a color that resembles a color of a displayed vehicle involved in the accident.

95. The system of claim 49, wherein the graphical manipulation includes moving the graphical displayed vehicle and rotating the graphically displayed vehicle.

96. (canceled)

97. A carrier medium comprising program instructions, wherein the program instructions are executable by a computer system to implement a method of: graphically displaying at least one vehicle involved in an accident;
graphically manipulating at least one graphically displayed vehicle;
receiving an impact point from a user for at least one displayed vehicle; and
determining fault for at least one displayed vehicle based at least partially on the received impact point.

98. The carrier medium of claim 97, further comprising collecting additional information about at least one displayed vehicle.

99. The carrier medium of claim 98, wherein the additional information includes an accident type.

100-102. (canceled)

103. The carrier medium of claim 98, wherein the additional information includes a roadway type.

104. (canceled)

105. The carrier medium of claim 103, further comprising displaying a graphical representation of the roadway type relative to at least one displayed vehicle.

106. The carrier medium of claim 105, further comprising displaying at least one vehicle over the representation of the roadway.

107. (canceled)

108. The carrier medium of claim 98, wherein additional information includes a vehicle type.

109-117. (canceled)

118. The carrier medium of claim 98, wherein the additional information is collected from at least two sources.

119. The carrier medium of claim 98, wherein a user enters a numerical value to represent an orientation of at least one displayed vehicle.

120-121. (canceled)

122. The carrier medium of claim 97, wherein the impact point is displayed using at least one color that is similar to a color used for displaying at least one other displayed vehicle involved in the accident.

123. The carrier medium of claim 97, further comprising graphically manipulating at least one displayed vehicle to resemble an approximate positioning of at least one displayed vehicle during an impact.

124. The carrier medium of claim 123, wherein the impact points are selected by the computer based on the user's positioning of at least one displayed vehicle.

125. The carrier medium of claim 123, wherein at least one displayed vehicle is manipulated by clicking a mouse pointer on at least one displayed vehicle and rotating at least one displayed vehicle using the mouse.

126. The carrier medium of claim 123, wherein at least one displayed vehicle is selected to be manipulated by selecting a radio button respective to at least one displayed vehicle.

127. The carrier medium of claim 123, wherein an at least one displayed vehicle is rotated by clicking on a graphic.

128. The carrier medium of claim 123, wherein a menu provides at least two options for an orientation of at least one displayed vehicle.

129. The carrier medium of claim 123, wherein a graphic is displayed over at least one displayed vehicle and the orientation of the displayed vehicle is selected by selecting a point on the graphic.

130. The carrier medium of claim 123, further comprising displaying an orientation graphic relative to at least one displayed vehicle, wherein a user uses arrow keys on a keyboard to rotate at least one displayed vehicle.

131. The carrier medium of claim 97, wherein at least two displayed vehicles are graphically attached at a respective impact point.

132. The carrier medium of claim 131, wherein the displayed vehicles are graphically rotatable as a whole to position the displayed vehicles relative to an accident.

133. The carrier medium of claim 97, further comprising receiving at least two positionings of at least one displayed vehicle.

134. The carrier medium of claim 133, wherein the at least two positionings are received respective to a time comprised of at least one of before the impact, during the impact, and after the impact.

135. The carrier medium of claim 133, further comprising displaying at least two positionings of at least one displayed vehicle in a chronological sequence.

136. (canceled)

137. The carrier medium of claim 97, wherein the impact point comprises at least one of right front corner, right fender, right middle, right quarter panel, right rear corner, rear middle, left rear corner, left quarter panel, left middle, left fender, left front corner, and front middle.

138. The carrier medium of claim 97, further comprising:
collecting a roadway type and an accident type;
establishing bounds based on the roadway type and accident type for the user to graphically position at least one displayed vehicle.

139. The carrier medium of claim 97, further comprising labeling at least one displayed vehicle as an insured's vehicle or as a claimant's vehicle.

140. The carrier medium of claim 139, wherein the label is in an upright position regardless of the positioning of at least one displayed vehicle.

141. The carrier medium of claim 97, wherein an impact point is represented by a point label, wherein the point label is displayed respective to at least one displayed vehicle in an upright position regardless of the positioning of at least one displayed vehicle.

142. The carrier medium of claim 97, wherein an impact point is displayed respective to at least one displayed vehicle with at least partially a color that resembles a color of a displayed vehicle involved in the accident.

143. The carrier medium of claim 97, wherein the graphical manipulation includes moving the graphical displayed vehicle and rotating the graphically displayed vehicle.

144. (canceled)
